(19) United States
(12) Patent Application Publication
(10) Pub. No.: US 2020/0049934 A1
(43) Pub. Date: Feb. 13, 2020

(54) LENS MODULE

(71) Applicant: AAC Technologies Pte. Ltd., Singapore city (SG)

(72) Inventor: Chuandong Wei, Shenzhen (CN)

(21) Appl. No.: 16/528,671

(22) Filed: Aug. 1, 2019

(30) Foreign Application Priority Data
Aug. 7, 2018 (CN) 201821285533.9

(51) Int. Cl. G02B 7/02

(52) U.S. Cl. CPC G02B 7/026; G02B 7/021

(57) ABSTRACT

The present disclosure relates to the technical field of optical lenses, and provides a lens module. The lens module includes a lens barrel, a first lens arranged at an object side of the lens barrel, a fixing part for pressing the first lens against the lens barrel from an object side of the first lens, and a sealing ring arranged between the lens barrel and the first lens. The sealing ring includes a top surface directly facing the first lens and a bottom surface directly facing the lens barrel. The top surface is provided with at least two first contacting portions around an optical axis of the first lens, and the at least two first contacting portions abut against the first lens. The lens module provided by the present disclosure has a higher reliability and a good sealing property.

### TECHNICAL FIELD

The present disclosure relates to the technical field of optical lenses, and in particular, to a lens module.

### BACKGROUND

With development of technologies, various devices are equipped with lens modules. For example, with respect to safety hazard of driving a vehicle, the vehicle is equipped with a vehicle-mounted lens module. In the related art, the vehicle-mounted lens module usually includes a lens barrel and a plurality of lenses received in the lens barrel.

The inventors have found that a problem existing in the prior art: the vehicle-mounted lens modules are subjected to external forces caused by, for example, vibration, friction, and collision during the use of the vehicle-mounted lens module, such that the vehicle-mounted lens module has a poor stability and is unsuitable for bad operating environment. Moreover, the vehicle-mounted lens module has such a poor sealing performance that external debris can easily enter the lens barrel and affect the optical performance of the lens. Therefore, it is urgent to provide a new lens module to solve the above problem.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic cross-sectional view of a lens module according to an embodiment of the present disclosure; and

FIG. 2 is a structural schematic cross-sectional view of a sealing ring according to an embodiment of the present disclosure.

### DESCRIPTION OF EMBODIMENTS

The present disclosure will be further illustrated with reference to the accompanying drawings and the embodiments.

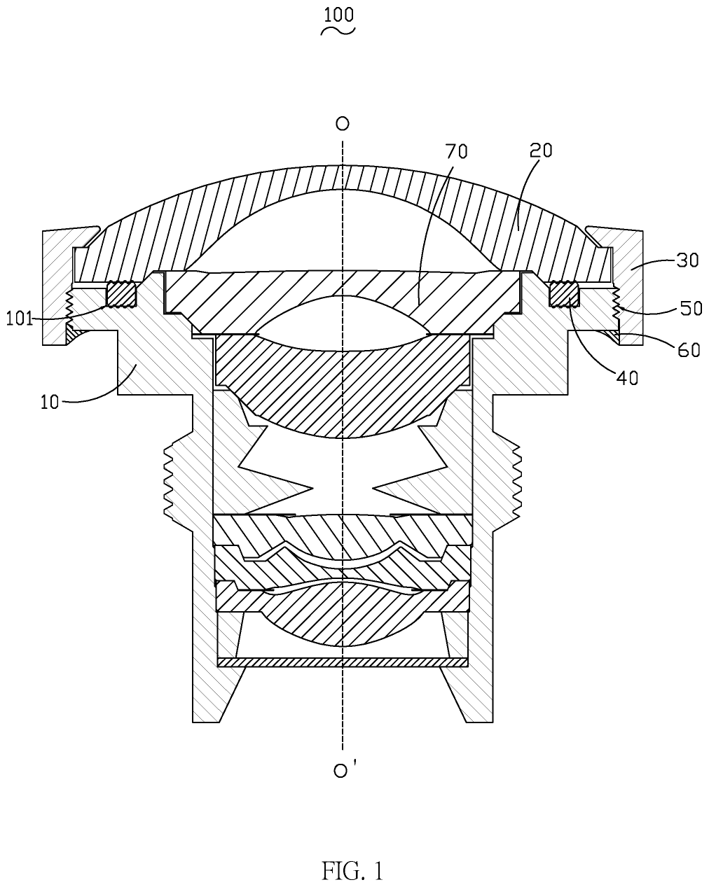

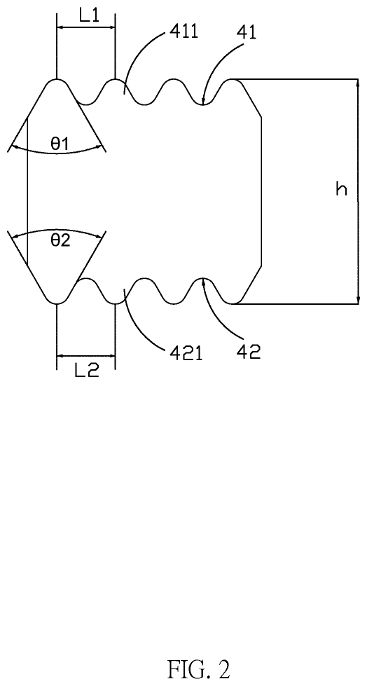

An embodiment of the present disclosure provides a lens module 100. As shown in FIG. 1, the lens module 100 includes a lens barrel 10, a first lens 20 arranged at an object side of the lens barrel 10, a fixing part 30 for pressing the first lens 20 against the lens barrel 10 from an object side of the first lens 20, and a sealing ring 40 arranged between the lens barrel 10 and the first lens 20. With further reference to FIG. 2, the sealing ring 40 includes a top surface 41 directly facing the first lens 20 and a bottom surface 42 directly facing the lens barrel 10. The top surface 41 is provided with at least two first contacting portions 411 around an optical axis OO′ of the first lens 20. The first contacting portions 411 abut against the first lens 20.

Compared with the related art, in this embodiment of the present disclosure, the fixing part 30 presses the first lens 20 against the lens barrel 10 to fix of the first lens 20 to the lens barrel 10. The sealing ring 40 arranged between the first lens 20 and the lens barrel 10 ensures that the first lens 20 is tightly attached to the lens barrel 10, thereby preventing looseness of the first lens 20 and thus improving reliability of the lens module 100. The top surface 41 of the sealing ring 40 is provided with at least two first contacting portions 411 around the optical axis OO′ of the first lens 20, and the first contacting portions 411 abut against the first lens 20. In this way, a path via which external debris enters the lens barrel 10 through an abutting position between the lens barrel 10 and the first lens 20 is lengthened, thereby improving the sealing performance of the lens module 100.

Preferably, the lens barrel 10 is provided with a groove 101 for receiving the sealing ring 40, and thus the effective space occupied by the sealing ring 40 in the lens module 100 is reduced, which is conducive to the miniaturization of the lens module 100. In this embodiment, the groove 101 has an annular shape around the optical axis of the lens module.

It should be understood that, in this embodiment, the sealing ring 40 is a serrated sealing rubber gasket, and a thickness h of the sealing rubber gasket has in a direction parallel to the optical axis OO′ is adjusted depending upon the actual situation. During the assembling, the sealing ring 40 is placed in the groove 101, the first lens 20 is positively engaged with the lens barrel from the object side and presses the sealing ring 40 with its surface close to an image side, and thus the sealing ring 40 is deformed to achieve a sealing effect. It should be noted that the features of the sealing ring 40 described in this embodiment are those of the sealing ring before the deformation.

Specifically, each first contacting portion 411 at the top surface 41 includes two oblique surfaces that extend from the top surface 41 towards the first lens 20 and intersect at an end facing away from the top surface 41, where an angle θ₁ formed by the two oblique surfaces is an acute angle.

Preferably, the intersection position of the two oblique surfaces is formed as a rounded angle, which can increase a contact area between each first contacting portion 411 and the first lens 20, thereby further preventing external debris from entering the lens barrel 10 via a connecting position between the lens barrel 10 and the first lens 20. It should be noted that a curvature radius of the rounded angle is not greater than 0.5 mm, so that a width of the first contacting portion 411 is not excessively increased, thereby increasing a number of the first contacting portions 411 arranged on the top surface 41.

It should be noted that an intersection line is formed by two oblique surfaces of each first contacting portion 411, and a distance L₁ between any two adjacent intersection lines is not smaller than 0.05 mm but not larger than 0.8 mm. In this way, while avoiding an excessively dense distribution of the first contacting portions 411 on the top surface 41, the path via which external debris enters the lens barrel 10 can be ensured to be as long as possible.

More preferably, the bottom surface 42 is provided with at least two second contacting portions 421 around the optical axis OO′ of the first lens 20. The second contacting portions 421 abut against the lens barrel 10. In this way, the sealing between the sealing ring 40 and the lens barrel 10 can be increased, and the path via which external debris enters the lens barrel 10 from an image side of the sealing ring 40 can be lengthened.

Specifically, each second contacting portion 421 includes two oblique surfaces that extend from the bottom surface 42 towards the lens barrel 10 and intersect at an end facing away from the bottom surface 42, where an angle θ₂ formed by two oblique surfaces is an acute angle.

Preferably, an intersection position of the two oblique surfaces is formed as a rounded angle, which increases a contact area between each second contacting portion 421 and the lens barrel 10, thereby further preventing external debris from entering the lens barrel 10 via the connecting position between the lens barrel 10 and the first lens 20. Moreover, a curvature radius of the rounded angle is not larger than 0.5 mm.

More preferably, an intersection line is formed by two oblique surfaces of each second contacting portion 421, and a distance L₂ between any two adjacent intersection lines is not smaller than 0.05 mm but not larger than 0.8 mm. In this way, while avoiding an excessively dense distribution of the second contacting portions 421 on the bottom surface 42, the path via which external debris enters the lens barrel 10 can be ensured to be as long as possible.

It should be noted that, the lens module 100 is provided with threads 50 for fixedly connecting the barrel wall 11 with the fixing part 30. In this embodiment, the fixing part 30 is a screw cap. During the assembling, the fixing part 30 is arranged at the object side of the lens barrel 10, and an end of the lens barrel 10 close to the object side is screwed into the fixing part 30, so as to tightly connect the fixing part 30 to the lens barrel 10. In this way, it can prevent the first lens 20 arranged between the lens barrel 10 and the fixing part 30 from departing from the lens barrel 10, and ensure a more stable fixation structure of the first lens 20, the fixing part 30 and the lens barrel 10, thereby further improving the reliability of the lens module 100.

Preferably, the lens module 100 is further provided with a thermosetting glue 60 for fixedly connecting the barrel wall 11 with the fixing part 30. The thermosetting glue 60 is provided at the connecting position between the lens barrel 10 and the fixing part 30 to reduce a probability of the failure of the threads 50, thereby further improving the reliability of the lens module 100. Meanwhile, the thermosetting glue 60 can prevent external debris from entering the lens module 100 via the connecting position between lens barrel 10 and the fixing part 30, thereby further optimizing the sealing property of the lens module 100.

It should be understood by those skilled in the art that the lens module 100 may further include at least one second lens 70 received in the lens barrel 10 and located at the image side of the first lens 20.

It should be understood by those skilled in the art that the above embodiments are merely some specific embodiments of the present disclosure, and various changes in form and details may be made without departing from the scope of the present disclosure.

What is claimed is:

1. A lens module, comprising:
a lens barrel;
a first lens arranged at an object side of the lens barrel;
a fixing part for pressing the first lens against the lens barrel from an object side of the first lens; and
a sealing ring arranged between the lens barrel and the first lens,
wherein the sealing ring comprises a top surface directly facing the first lens and a bottom surface directly facing the lens barrel, the top surface is provided with at least two first contacting portions around an optical axis of the first lens, and the at least two first contacting portions abut against the first lens.

2. The lens module as described in claim 1, wherein each of the at least two first contacting portions comprises two oblique surfaces that extend from the top surface towards the first lens and intersect at an end facing away from the top surface, an angle formed between the two oblique surfaces being an acute angle.

3. The lens module as described in claim 2, wherein a rounded angle is formed at an intersection end of the two oblique surfaces.

4. The lens module as described in claim 3, wherein a curvature radius of the rounded angle is smaller than or equal to 0.5 mm.

5. The lens module as described in claim 2, wherein an intersection line is formed by the two oblique surfaces of each of the at least two first contacting portions, and a distance between any two adjacent intersection lines is greater than or equal to 0.05 mm, and smaller than or equal to 0.8 mm.

6. The lens module as described in claim 1, wherein the bottom surface is provided with at least two second contacting portions around the optical axis of the first lens, and the at least two second contacting portions abut against the lens barrel.

7. The lens module as described in claim 6, wherein each of the at least two second contacting portions comprises two oblique surfaces that extend from the bottom surface towards the lens barrel and intersect at an end facing away from the bottom surface, an angle formed between the two oblique surfaces is an acute angle.

8. The lens module as described in claim 7, wherein a rounded angle is formed at an intersection end of the two oblique surfaces.

9. The lens module as described in claim 8, wherein a curvature radius of the rounded angle is smaller than or equal to 0.5 mm.

10. The lens module as described in claim 7, wherein an intersection line is formed by the two oblique surfaces of each of the at least two second contacting portions, and a distance between any two adjacent intersection line is greater than or equal to 0.05 mm, and smaller than or equal to 0.8 mm.
